(19) United States
(12) Patent Application Publication
(10) Pub. No.: US 2019/0325409 A1
(43) Pub. Date: Oct. 24, 2019

(54) INTERACTION PROCESSING WITH VIRTUAL COUNTER-PARTY IDENTIFICATION

(71) Applicant: GOOGLE LLC, Mountain View, CA (US)

(72) Inventors: Arjita Madan, New Delhi (IN); Sumit Gwalani, Mumbai (IN)

(21) Appl. No.: 16/387,253

(22) Filed: Apr. 17, 2019

(30) Foreign Application Priority Data
Apr. 20, 2018 (IN) 201841015033

(51) Int. Cl. G06Q 20/08; G06K 19/06

(52) U.S. Cl. CPC G06Q 20/085; G06K 19/06037

(57) ABSTRACT

To conduct an interaction with a counter-party, a user opens an application on a user computing device and initiates a process to transfer electronic records. The destination of the interaction, such as a recipient counter-party, is identified and a transfer flow is initiated. The user computing device receives an input of the identification of a counter-party for the interaction. The user computing device communicates to a server, such as a processing system server, that an interaction with the counter-party is desired. The processing system server identifies the destination account of the counter-party and the interaction details. The interaction is conducted and electronic records are deposited in the destination account of the counter-party. The counter-party and the user computing system are notified of the successful interaction.

### CROSS-REFERENCE TO RELATED APPLICATION

This patent application claims priority to Indian Provisional Patent Application No. 201841015033, filed Apr. 20, 2018 and entitled “Processing User Interactions.” The entire contents of the above-identified application are hereby fully incorporated herein by reference.

### TECHNICAL FIELD

The examples herein describe a method to process interactions using a virtual counter-party identification. The interaction using the virtual counter-party identification may be conducted without a user input after an indication of a request to proceed with the interaction.

### BACKGROUND

Machine-readable codes are used for a very large and rapidly growing number of user interactions, both in the United States and in foreign markets. For example, a quick response (“QR”) code or other machine-readable code allows a merchant to provide data to a user to allow interactions to proceed. For interactions in conventional systems, such as the BharatQR system in India, the merchant presents a standard merchant QR code to a user. BharatQR allows a merchant to accept data records via cards or bank-to-bank payment systems. BharatQR codes may be provided to a merchant by their acquiring bank, and contain information about the merchant system as well as the merchant account. However, processing interactions based on QR codes can be insecure, prone to fraud, and cumbersome for users. When a user scans a QR code to initiate an interaction, the user is unaware of where the QR code is directing the user computing device. QR codes can be easily created, which provides an environment open to insecure interactions and fraud. Trojans and computer viruses can be easily transmitted through such interactions. In addition, processing a machine-readable code often involves opening a third party application on the user computing device, selecting four or more options in the user interface, scanning the machine-readable code, and then entering interaction details in order to complete the processing of the interaction. A burden is placed on the merchant as the merchant configures a system to interact with the third party application to process the interaction.

### SUMMARY

Techniques herein provide computer-implemented methods to process interactions initiated by user computing devices. The computer-implemented methods configure a destination record for a counter-party of an interaction. The configuration includes an identification of the counter-party. A request is received from a user computing device to transfer electronic data to the destination record of the counter-party. The request is comprised of the identification of the counter-party. Electronic data is transferred from a record associated with the user computing device to the destination record. A notification is communicated indicating the completion of the transfer of the electronic data.

These and other aspects, objects, features, and advantages of the examples will become apparent to those having ordinary skill in the art upon consideration of the following detailed description of illustrated examples.

### BRIEF DESCRIPTION OF THE DRAWINGS

FIG. 1 is a block diagram depicting a system for conducting a transaction with a merchant with virtual merchant codes, in accordance with certain examples.

FIG. 2 is a block flow diagram depicting a method for conducting a transaction with a merchant with virtual merchant codes, in accordance with certain examples.

FIG. 3 is a block flow diagram depicting a method for a payment processing system to conduct transaction between the payment application and the merchant computing system, in accordance with certain examples.

FIG. 4 is a block diagram depicting a computing machine and module, in accordance with certain examples.

### OVERVIEW

In a desired user experience, a user opens a payment application on a user computing device and initiates a process to transfer electronic records, such as in a purchase transaction. The electronic records may contain data necessary to conduct a financial transaction. For example, the user computing device receives an input of a counter-party identification for the transaction, such as a merchant computing system identification. The merchant computing system identification may be a virtual or electronic identification as opposed to a physical identification such as a QR code. The user computing device communicates to a server, such as a payment processing system server, that a transaction with the merchant computing system associated with the merchant computing system identification is desired. The payment processing system server identifies the destination account of the merchant computing system and the transaction details. The transaction is conducted and electronic records, such as funds, are deposited in the destination account of the merchant computing system. The merchant computing system and the user computing device are notified of the successful transaction.

The payment application receives an input of the merchant computing system identification, without a separate application for scanning QR codes. The input may be based on a global positioning system (“GPS”) of the user computing device, where the user computing device identifies the merchant computing system based on the location of the user computing device. A user may input the merchant identification directly into the payment application, such as by manually typing in data identifying the merchant computing system or by saying the merchant name into a voice recognition application of the user computing device. The user may input the merchant identification directly into the payment application by selecting the merchant computing system from a list of merchants. Any other suitable entry method to provide the merchant computing system identification may be utilized.

After the payment application receives the input of the merchant computing system identification, the user then enters an amount for the transaction and selects an option on the user interface to confirm the transaction in an opened payment application or other suitable application. A transaction may be automatically initiated based on the user opening the payment application. Upon opening, the payment application identifies the merchant computing system identification and requests transaction details from the user, such as a transaction amount.

The payment application communicates the transaction data to the payment processing system to request that the transaction amount be transmitted to the destination account of the merchant computing system. The payment processing system uses the merchant computing system identification to access data associated with the merchant computing system. The data comprises information associated with the destination account, such as the type of account, the types of payments the account can receive, the financial institution that hosts the account, or any other suitable data.

The payment processing system transmits the funds for the transaction to the account of the merchant computing system. The transmission of funds may be by any suitable method, technology, or financial process. The transmission may be a bank transfer of funds from an account of the user to the destination account of the merchant computing system. The transfer may be a credit card transfer that employs a credit card network to transmit the funds to the destination account of the merchant computing system. The merchant computing system may have a financial account associated with the payment processing system, and the payment processing system may credit the account of the merchant computing system. The transfer may be a peer-to-peer transfer that employs peer-to-peer financial transaction accounts to transmit the funds to the merchant computing system. Any suitable method to transfer funds may be employed.

The payment processing system communicates a notification of the successful transfer of funds, or other notification of a completion of the transaction, to the merchant computing system and the payment application. Upon receipt of the notification, the merchant computing system completes the transaction, such as by providing the purchased product to the user.

By using and relying on the methods and systems described herein, the user experiences secure, fast payment flow, which results in a better experience for the user. The user may conduct a transaction by simply opening a payment application and inputting, selecting, or verifying a merchant. In a conventional system, the user scans a QR code or performs any other actions to interact with the merchant system. QR codes can be easily created, which provides an environment open to insecure transactions and fraud. Trojans and computer viruses can be easily transmitted through such transactions. The user enters the transaction details, determines if a merchant will accept the preferred payment type, selects an available payment type, and verifies the transaction details. These conventional steps utilize additional system processing and communication capacities, introduce more opportunities for error, and frequently discourage a user from proceeding. The features of the methods and systems described herein allow for secure transactions, faster processing, less communication capacity, and reduced errors as compared to conventional systems. The system also includes an ability to support third party payment applications, which provides payment options in addition to the standard payment options accepted by the merchant system. For example, a user may make a payment from a bank account to a merchant system that only accepts credit card payments.

### Example System Architecture

Turning now to the drawings, in which like numerals indicate like (but not necessarily identical) elements throughout the figures, examples are described in detail.

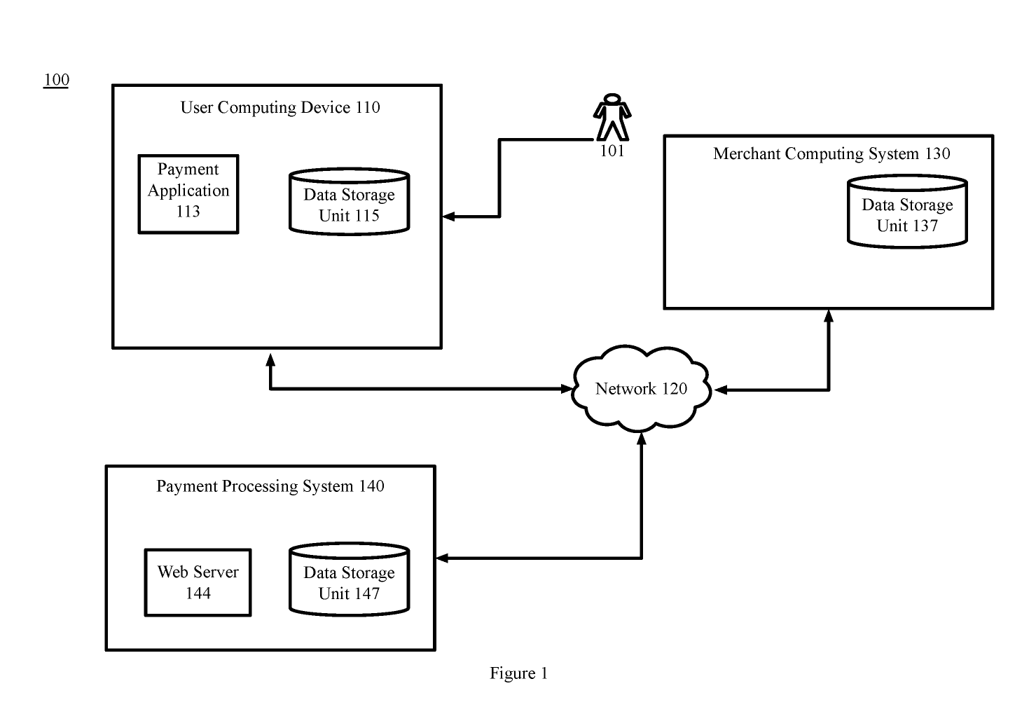

FIG. 1 is a block diagram depicting a system 100 for conducting a transaction with a merchant with virtual merchant codes, in accordance with certain examples. As depicted in FIG. 1, the system 100 comprises network computing devices 110, 130, and 140 that are configured to communicate with one another via one or more networks 120. In some embodiments, a user associated with a device installs an application and/or makes a feature selection to obtain the benefits of the techniques described herein.

The network 120 may include a local area network (“LAN”), a wide area network (“WAN”), an intranet, an Internet, a storage area network (“SAN”), a personal area network (“PAN”), a metropolitan area network (“MAN”), a wireless local area network (“WLAN”), a virtual private network (“VPN”), a cellular or other mobile communication network, Bluetooth, Bluetooth low energy (“BLE”), near field communication (“NFC”), ultrasound communication, or any combination thereof or any other appropriate architecture or system that facilitates the communication of signals, data, and/or messages. Throughout the discussion of examples, the terms “data” and “information” may be used interchangeably herein to refer to text, images, audio, video, or any other form of information that can exist in a computer-based environment.

Each network computing device 110, 130, and 140 includes a device having a communication module capable of transmitting and receiving data over the network 120. For example, each network computing device 110, 130, and 140 can include a server, desktop computer, laptop computer, tablet computer, a television with one or more processors embedded therein and/or coupled thereto, smart phone, handheld computer, personal digital assistant (“PDA”), video game device, wearable computing device, or any other wired or wireless, processor-driven device. In the example depicted in FIG. 1, the network computing devices 110, 130, and 140 are operated by users 101, merchant operators, and payment processing system 140 operators, respectively.

An example user computing device 110 comprises a payment application 113 and a data storage unit 115.

The payment application 113 is a program, function, routine, applet, or similar entity that exists on and performs application operations on the user computing device 110. The user 101 installs the payment application 113 and/or makes a feature selection on the user computing device 110 to obtain the benefits of the techniques described herein. The user 101 may access the payment application 113 on the user computing device 110 via a user interface. The payment application 113 may be associated with the payment processing system 140. The payment application 113 may be associated with a merchant computing system 130.

The data storage unit 115 may comprise a local or remote data storage structure accessible to the user computing device 110 suitable for storing information. The data storage unit 115 may store encrypted information, such as HTML5 local storage.

An example payment processing system 140 is configured to conduct transactions for a payment account of a user 101. The payment processing system 140 receives requests to conduct transactions from the user 101 or a merchant computing system 130, and provides an authorization for the transaction. The payment processing system 140 may receive an authorization for the transaction from a card issuer or other financial institution, or the payment processing system 140 may provide the authorization. The payment processing system 140 may be associated with the payment application 113 or another payment instrument of the user 101 or the merchant computing system 130.

The data storage unit 145 may comprise a local or remote data storage structure accessible to the payment processing system 140 suitable for storing information. The data storage unit 145 may store encrypted information, such as HTML5 local storage.

An example merchant computing system 130 is configured to conduct transactions with user 101. The merchant computing system 130 offers products, services, or other items for sale to user 101 in an online environment or at a physical location. The merchant computing system 130 may accept payments in any suitable form, such as credit or debit payments, bank transfers, peer-to-peer payments, or any other suitable payment type. The merchant computing system 130 registers with the payment processing system 140 and configures an account. The merchant computing system 130 inputs the destination account for receiving payments via the payment processing system 140. The destination account may be associated with a banking or financial institution, a credit or debit card issuer, a peer-to-peer payment system, or any other suitable account system. The destination account may be associated with the payment processing system 140. The payment processing system 140 may host a financial account of the merchant computing system 130 and receive payments for the merchant computing system 130.

The data storage unit 135 may comprise a local or remote data storage structure accessible to the merchant computing system 130 suitable for storing information. The data storage unit 135 may store encrypted information, such as HTML5 local storage.

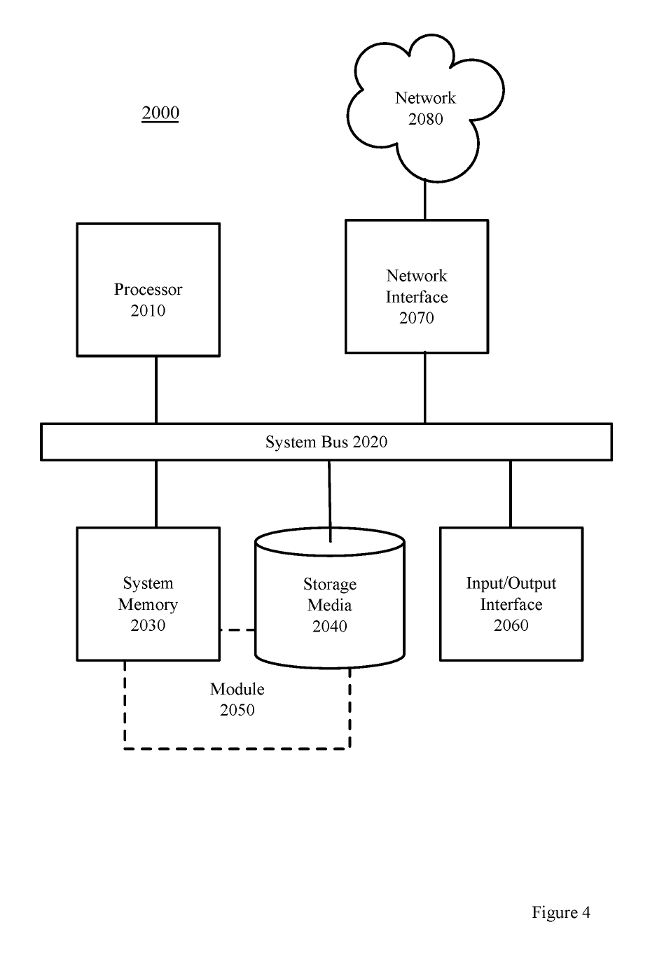

The network computing devices and any other computing machines associated with the technology presented herein may be any type of computing machine such as, but not limited to, those discussed in more detail with respect to FIG. 4. Furthermore, any functions, applications, or modules associated with any of these computing machines, such as those described herein or any others (for example, scripts, web content, software, firmware, or hardware) associated with the technology presented herein may by any of the modules discussed in more detail with respect to FIG. 4. The computing machines discussed herein may communicate with one another, as well as with other computing machines or communication systems over one or more networks, such as network 120. Network 120 may include any type of data or communications network, including any of the network technology discussed with respect to FIG. 4.

### Example Processes

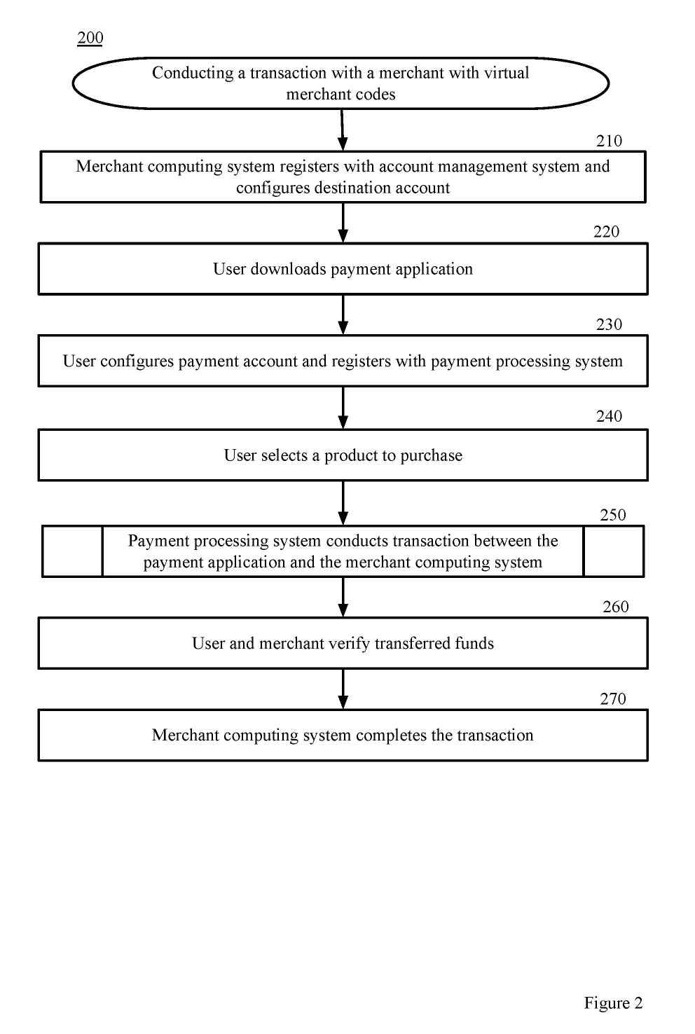

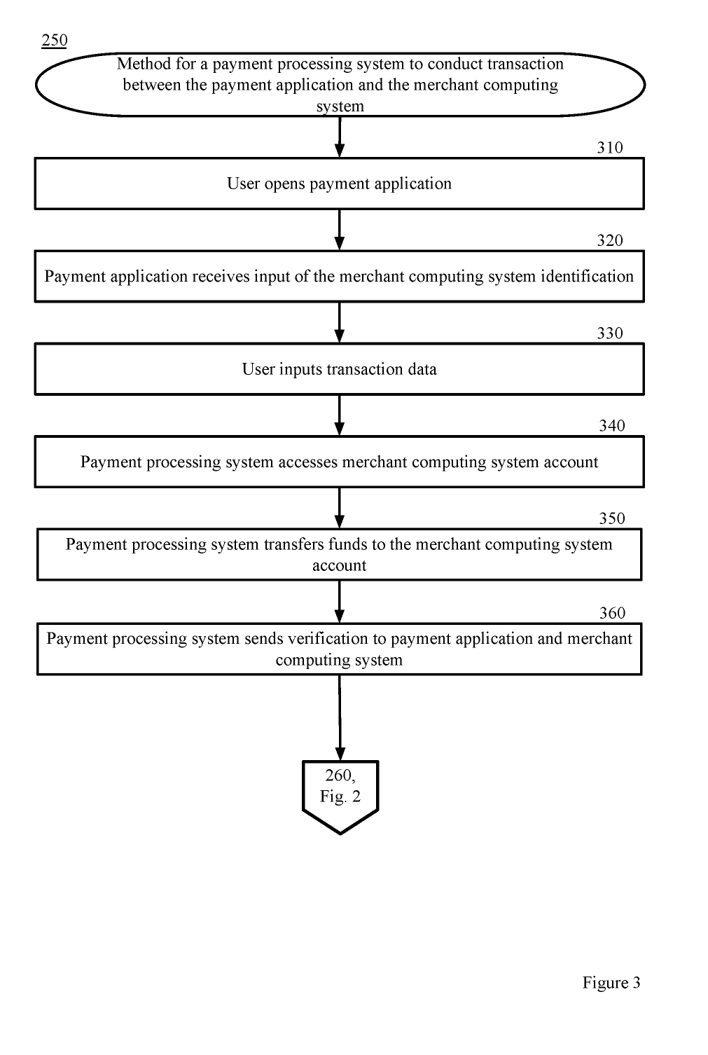

The example methods illustrated in FIGS. 2-3 are described hereinafter with respect to the components of the example operating environment 100. The example methods of FIGS. 2-3 may also be performed with other systems and in other environments.

FIG. 2 is a block flow diagram depicting a method 200 for conducting a transaction with a merchant computing system 130 with virtual merchant codes, in accordance with certain examples.

In block 210, a system for interacting with a user 101, such as a merchant computing system 130, registers with an account management system. Registering with the account management system establishes an electronic record, such as an account, associated with the merchant computing system 130. The account is a destination record, or destination account, for payments to the merchant computing system 130. The destination account may be a financial account associated with a banking or financial institution, a credit or debit card issuer, a peer-to-peer payment system, or any other suitable account system. The account management system may be a credit card issuer, a debit card issuer, a bank, or other financial institution that hosts the destination account for the merchant computing system 130. The destination account may be associated with and hosted by the payment processing system 140.

In block 220, the user 101 downloads a payment application 113 on the user computing device 110. The payment application 113 is a program, function, routine, applet, or similar entity that exists on and performs its operations on the user computing device 110. The user 101 installs the payment application 113 and/or makes a feature selection on the user computing device 110 to obtain the benefits of the techniques described herein. The user 101 may access the payment application 113 on the user computing device 110 via a user interface. The payment application 113 may be associated with the payment processing system 140, the merchant computing system 130, or a third-party system, such as a credit card issuer, financial institution, or the manufacturer of the user computing device 110.

In block 230, the user 101 configures a record, or payment account, and registers with the payment processing system 140. The payment application 113 allows a user 101 to conduct a financial transaction via an associated record, or payment account. For example, the payment application 113 may have stored a financial account of the user 101, such as a credit card account, a debit card account, or a banking account. The account of the user 101 may be managed by the merchant computing system 130, the payment processing system 140, or a by a third party system, such as a credit card issuer or a banking institution.

The user 101 may have more than one financial account stored with the payment application 113. For example, the user 101 may have a credit card account and a debit card account stored with the payment application 113. When the user 101 attempts to initiate a transaction, the payment application 113 may request a selection of the account to utilize. The payment application 113 may be able to automatically select the account to utilize without a user 101 interaction. For example, the payment application 113 learns the account the user 101 prefers for each type of merchant. The user 101 may prefer to use a certain credit card for all fuel purchases. The user 101 may select the same debit card for every purchase at a particular grocery store. Any other suitable criteria may be employed to predict and select the preferred card for a pending transaction.

In block 240, the user 101 selects a product to purchase. The product may be any physical item or service, or tangible or intangible product. The product may be available for purchase at a physical location associated with the merchant computing system 130 or any other suitable location such as an online merchant computing system 130. The user 101 takes the product to a point of sale (“POS”), a sales counter, a virtual checkout page, or other point of interaction for purchasing the product.

In block 250 of method 200, the payment processing system 140 conducts a transaction between the payment application 113 and the merchant computing system 130. The details of block 250 are described in greater detail in the method 250 of FIG. 3.

FIG. 3 is a block flow diagram depicting a method 250 for a payment processing system 140 to conduct transactions between the payment application 113 and the merchant computing system 130, in accordance with certain examples.

In block 310, a user 101 opens the payment application 113 on the user computing device 110. The user 101 may actuate an object on the user interface of the user computing device 110 to initiate the payment application 113. The payment application 113 may open automatically upon detecting that the user 101 is at a location of the merchant computing system 130.

In block 320, the payment application 113 receives an input of the identification of the merchant computing system 130. The input of the merchant computing system 130 identification may be automatically provided by the user computing device 110 or manually by the user 101. The user computing device 110 may identify the merchant computing system 130 based on the location of the user computing device 110. For example, the user computing device 110 utilizes a global positioning system (“GPS”) component of the user computing device 110 to determine a location of the user 101 and the user computing device 110. The user computing device 110 may compare the determined location to a database of merchant locations to identify the location of the merchant computing system 130 at which the user computing device 110 is located. The user computing device 110 may automatically select the merchant computing system 130 based on the comparison of the location of the user 101 and the user computing device 110 to the database of merchant locations, and provide the identification of the selected merchant computing system 130 to the payment application 113, without an input from the user 101. Alternatively, the user computing device 110 may present the selected merchant computing system 130 to the user 101 for verification. The user 101 may verify the selected merchant computing system 130 through an interface object presented on a user interface on the user computing device 130 or through any other suitable verification method. The identification of the selected merchant computing system 130 may then be communicated to the payment application 113 by the user computing device 110.

The user computing device 110 may receive a beacon or other transmission from the merchant computing system 130, where the identification of the merchant computing system 130 is included in the beacon. Based on the beacon, the user computing device 110 identifies the merchant computing system 130, without an input from the user 101. The user computing device 110 communicates the identification of the merchant computing system 130 to the payment application 113, without an input from the user 101.

The user 101 may input the merchant identification directly into the payment application 113, such as by manually typing in data identifying the merchant computing system 130. The user 101 may input the merchant identification directly into the payment application 113 by selecting the merchant computing system 130 from a list of merchants. The user 101 may input the merchant identification directly into the payment application 113 by speaking a name identifying the merchant computing system 130 into the user computing device 110, where the name of the merchant computing system is identified by a voice recognition application installed on the user computing device 110. Any other suitable entry methods may be utilized.

After the user 101 inputs the merchant identification, the user computing device 110 displays the merchant identification to the user 101. The user 101 may select an option to confirm the merchant identification or refuse the merchant identification. The user 101 may alternatively proceed with the interaction if the display is correct. If the user 101 refuses the merchant identification, the user 101 may re-enter the merchant identification until the correct merchant identification is displayed.

In block 330, the user 101 inputs transaction data into the payment application 113. For example, the user 101 types in the transaction amount to purchase the product. The user 101 enters an amount for the transaction and selects an option on the user interface to confirm the transaction in the opened payment application 113 or other application. In certain examples, a transaction may be automatically initiated based on opening the payment application 113. Upon opening, the payment application 113 identifies the merchant computing system 130 and requests electronic data, or transaction details, from the user 101, such as a transaction amount.

In block 340, the payment processing system 140 accesses the account of the merchant computing system 130. As described in block 210, the merchant computing system 130 has associated a destination account for funds to be received from user 101. Any type of account that the merchant computing system 130 has configured as the destination account may be accessed, such as a banking account, a credit card account, or a peer-to-peer transaction account. The account may be managed by the payment processing system 140 or any other suitable account manager. For example, the account of the merchant computing system 130 may not be managed by the same account manager as the account of the user 101. Third party accounts, or any other type of account may be utilized. When the payment processing system 140 receives the identification of the merchant computing system 130, the payment processing system 140 accesses the account of the merchant computing system 130 based on the identification.

In block 350, the payment processing system 140 transfers funds to the destination account of the merchant computing system 130. The payment processing system 140 determines the type of account that the merchant computing system 130 is using as a destination account and configures the transfer of funds accordingly. For example, if the destination account is a banking account, the payment processing system 140 may perform a bank-to-bank fund transfer. If the destination account is a credit card account, the payment processing system 140 may perform a transfer of funds via a credit card network system. The type of destination account that the merchant computing system 130 utilizes does not affect the operation of the payment application 113. The payment processing system 140 compensates for any difference between the payment options of the payment application 113 and the destination account of the merchant computing system 130. For example, if the payment application 113 employs a credit card payment system to transfer funds, and the merchant computing system 130 employs a peer-to-peer transaction system, the transaction may still be conducted by the payment processing system 140.

The payment processing system 140 transfers an amount of funds to the destination account based on the transaction details provided by the payment application 113. For example, if the user 101 indicates that the transaction is for $100, the payment processing system 140 transfers that amount to the destination account. The payment processing system 140 may communicate a request to the merchant computing system 130 for a specified amount of funds for the transaction. The merchant computing system 130 may communicate the amount of funds and any other transaction data to the payment processing system 140 or to the payment application 113.

The payment processing system 140 debits the account of the user 101 that is used to transfer the funds. For example, if the transferring account is a banking account, the payment processing system 140 may perform a bank-to-bank fund transfer. If the transferring account is a credit card account, the payment processing system 140 may perform a transfer of funds via a credit card network system. The type of transferring account that the user 101 utilizes does not affect the operation of the merchant computing system 130. The payment processing system 140 compensates for any difference between the payment options of the payment application 113 and the destination account of the merchant computing system 130.

The conversion of the funds from the account type of the user 101 to an account type of the merchant computing system 130 may be stored by the payment processing system 140 for use in subsequent transactions. The payment processing system 140 accesses the types of accounts being used during the transaction and is able to efficiently transfer funds between the two types of accounts. This database of account types may be stored centrally or stored in local databases to allow the user 101 to experience more efficient subsequent transactions.

In block 360, the payment processing system 140 sends a verification to the payment application 113 and the merchant computing system 130. The communication verifies that the funds have been transferred to the destination account. The communication is sent to the payment application 113 and the merchant computing system 130 via any suitable technology, such as an instant message over the Internet, an email, a text message, or any other suitable technology.

From block 360, the method 250 proceeds to block 260 of FIG. 2.

Returning to FIG. 2, in block 260 the user 101 and the merchant computing system 130 verify that the funds have been transferred. For example, the payment application 113 displays a message to the user 101 via a user interface on user computing device 110 that the funds have been transferred to the merchant computing device 130. The merchant computing device 130 indicates to an operator or salesperson that the funds have been transferred via a user interface of the merchant computing system 130 or any other suitable system. The merchant computing system 130 may utilize an automated system to verify that the funds have been transmitted, such as in an online transaction. For example, the merchant computing system 130 receives a verification of the transfer and automatically records that the transaction may proceed.

In block 270, the merchant computing system 130 completes the transaction with the user 101. Upon receiving the verification, the merchant computing system 130 completes the transaction. For example, the merchant computing system 130 or an operator provides the product and a receipt to the user 101. The merchant computing system 130 and/or the payment application 113 may communicate to the payment processing system 140 that the transaction has been satisfactorily completed. For example, the user 101 may enter an input into the payment application 113 verifying that the product has been received from the merchant computing system 130. The merchant computing system 130 may also send a communication to the payment processing system 140 verifying that the payment amount was correct and the transaction has been completed.

### Other Examples

FIG. 4 depicts a computing machine 2000 and a module 2050 in accordance with certain examples. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a router or other network node, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. The system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCP”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. The system bus 2020 may be within the processor 2010, outside the processor 2010, or both. According to certain examples, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with an opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The examples described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different examples, and/or certain additional acts can be performed, without departing from the scope and spirit of various embodiments. Accordingly, such alternative embodiments are included in the scope of the following claims, which are to be accorded the broadest interpretation so as to encompass such alternate embodiments.

Although specific embodiments have been described above in detail, the description is merely for purposes of illustration. It should be appreciated, therefore, that many aspects described above are not intended as essential elements unless explicitly stated otherwise. Modifications of, and equivalent components or acts corresponding to, the disclosed aspects of the examples, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

1. A computer-implemented method to process interactions initiated by user computing devices, comprising:
by one or more computing devices:
configuring a destination record for a counter-party of an interaction, the configuration including an identification of the counter-party;
receiving a request from a user computing device to transfer electronic data to the destination record of the counter-party, the request comprising the identification of the counter-party;
transferring the electronic data from a record associated with the user computing device to the destination record; and
communicating a notification of the completion of the transfer of the electronic data.

2. The method of claim 1, wherein the identification of the counter-party is received by the user computing device from an input.

3. The method of claim 2, wherein the input of the identification comprises a voice input into the user computing device.

4. The method of claim 1, wherein the identification of the counter-party is received by the user computing device based on a location application operating on the user computing device.

5. The method of claim 1, wherein the destination record is one of a banking account, a credit card account, or a peer-to-peer account.

6. The method of claim 1, wherein the record associated with the user computing device is not a same type of record as the destination record.

7. The method of claim 1, wherein the counter-party is a merchant computing system.

8. The method of claim 1, wherein the transmitted electronic data are funds for a payment transaction.

9. The method of claim 1, further comprising receiving a notification from the counter-party that the electronic data was correct and that the interaction is complete.

10. The method of claim 1, further comprising receiving a notification from the user computing device that the interaction is complete.

11. The method of claim 1, wherein the destination record is managed by a third-party system.

12. The method of claim 1, wherein the record associated with the user computing device is managed by a third-party system.

13. A computer program product, comprising:
a non-transitory computer-readable medium having computer-executable program instructions embodied thereon that when executed by a computer cause the computer to process transactions initiated by user computing devices, the computer-executable program instructions comprising instructions to:
configure a destination account for a merchant computing system, the configuration including an identification of the merchant computing system;
receive a request from a user computing device to transfer funds to the destination account of the merchant computing system, the request comprising the identification of the merchant computing system;
transfer the funds from an account associated with the user computing device to the destination account; and
communicate a notification of the completion of the transfer of the funds.

14. The computer program product of claim 13, wherein the identification of the merchant computing system is received by the user computing device from an input.

15. The computer program product of claim 13, wherein the destination account is one of a banking account, a credit card account, or a peer-to-peer account.

16. The computer program product of claim 13, wherein the account associated with the user computing device is not a same type of account as the destination account.

17. A system to process transactions initiated by user computing devices, comprising:
a storage device,
a network device, and
a processor communicatively coupled to the storage device and the network device, wherein the processor executes application code instructions that are stored in the storage device to cause the system to:
receive a request from a user computing device to transfer funds to a destination account of a merchant computing system, the request comprising an identification of the merchant computing system;
transfer the funds from an account associated with the user computing device to the destination account; and
communicate a notification of the completion of the transfer of the funds.

18. The system of claim 17, wherein the processor further executes application code instructions to configure the destination account for the merchant computing system, the configuration including the identification of the merchant computing system.

19. The system of claim 17, wherein the identification of the merchant computing system is received by the user computing device based on a location application operating on the user computing device.

20. The system of claim 17, wherein the destination account is managed by a third-party system.
